(19) United States
(12) Patent Application Publication
(10) Pub. No.: US 2018/0197019 A1
(43) Pub. Date: Jul. 12, 2018

(54) VEHICLE BASED SELECTION

(71) Applicant: INTERNATIONAL BUSINESS MACHINES CORPORATION, Armonk, NY (US)

(72) Inventors: Vijay Ekambaram, Chennai (IN); Sarbajit K. Rakshit, Kolkata (IN)

(21) Appl. No.: 15/400,219

(22) Filed: Jan. 6, 2017

(51) Int. Cl. G06K 9/00; G06T 7/20; H04R 3/00

(52) U.S. Cl. CPC G06K 9/00791; G06T 7/20; G06K 9/00255; H04R 3/00; G06K 9/00288

(57) ABSTRACT

A method and system for automatically selecting an individual is provided. The method includes directing a vehicle to a specified quadrant of an interior portion of a structure comprising a plurality of individuals gathered for an information session. A group of individuals within the specified quadrant is monitored and analyzed via the vehicle in motion and an individual is selected based on results of the analysis. The first individual is determined to have a question with respect to the information session. The vehicle is directed to a precise location of the individual and a microphone is presented via the vehicle such that the individual recites the question via the microphone. The question is presented to a speaker of the information session via the microphone.

### FIELD

The present invention relates generally to a method for implementing a vehicle based information session selection process and in particular to a method and associated system for direction a vehicle to a specified quadrant of a structure and presenting a microphone to a specified individual located within the specified quadrant.

### BACKGROUND

Implementing interactive sessions typically includes an inaccurate process with little flexibility. Coordinating speakers with audience members typically involves an unreliable process that may be time consuming and require a large amount of resources. Accordingly, there exists a need in the art to overcome at least some of the deficiencies and limitations described herein above.

### SUMMARY

A first aspect of the invention provides an automated selection method comprising: directing, by a processor of a controller, a vehicle to an interior portion of a structure comprising a plurality of individuals gathered for an information session; directing, by the processor, the vehicle to a specified quadrant of the interior portion of the structure, the specified quadrant comprising a group of individuals of the plurality of individuals; monitoring, by the processor via the vehicle in motion, the group of individuals within the specified quadrant of the structure; analyzing, by the processor, the group of individuals based on results of the monitoring; selecting, by the processor based on results of the analyzing, a first individual of the group of individuals, the first individual determined to have a question with respect to the information session; directing, by the processor, the vehicle to a precise location of the first individual; presenting, by the processor to the first individual via the vehicle, a microphone, wherein the first individual recites the question via the microphone; and presenting, by the processor to a speaker of the information session and the plurality of individuals via the microphone, the question.

A second aspect of the invention provides a computer program product, comprising a computer readable hardware storage device storing a computer readable program code, the computer readable program code comprising an algorithm that when executed by a processor of a controller implements an automated selection method, the method comprising: directing, by the processor, a vehicle to an interior portion of a structure comprising a plurality of individuals gathered for an information session; directing, by the processor, the vehicle to a specified quadrant of the interior portion of the structure, the specified quadrant comprising a group of individuals of the plurality of individuals; monitoring, by the processor via the vehicle in motion, the group of individuals within the specified quadrant of the structure; analyzing, by the processor, the group of individuals based on results of the monitoring; selecting, by the processor based on results of the analyzing, a first individual of the group of individuals, the first individual determined to have a question with respect to the information session; directing, by the processor, the vehicle to a precise location of the first individual; presenting, by the processor to the first individual via the vehicle, a microphone, wherein the first individual recites the question via the microphone; and presenting, by the processor to a speaker of the information session and the plurality of individuals via the microphone, the question.

A third aspect of the invention provides a controller comprising a processor coupled to a computer-readable memory unit, the memory unit comprising instructions that when executed by the processor executes an automated selection method comprising: directing, by the processor, a vehicle to an interior portion of a structure comprising a plurality of individuals gathered for an information session; directing, by the processor, the vehicle to a specified quadrant of the interior portion of the structure, the specified quadrant comprising a group of individuals of the plurality of individuals; monitoring, by the processor via the vehicle in motion, the group of individuals within the specified quadrant of the structure; analyzing, by the processor, the group of individuals based on results of the monitoring; selecting, by the processor based on results of the analyzing, a first individual of the group of individuals, the first individual determined to have a question with respect to the information session; directing, by the processor, the vehicle to a precise location of the first individual; presenting, by the processor to the first individual via the vehicle, a microphone, wherein the first individual recites the question via the microphone; and presenting, by the processor to a speaker of the information session and the plurality of individuals via the microphone, the question.

The present invention advantageously provides a simple method and associated system capable of implementing interactive sessions.

### BRIEF DESCRIPTION OF THE DRAWINGS

FIG. 1 illustrates a system for enabling vehicles for automatically selecting audience members associated with informational sessions in an auditorium, in accordance with embodiments of the present invention.

FIG. 2 illustrates a system comprising vehicles enabled to automatically select audience members participating in informational sessions in an auditorium, in accordance with embodiments of the present invention.

FIG. 3 illustrates an actual view of an individual and a projected view of the individual, in accordance with embodiments of the present invention.

FIG. 4 illustrates an algorithm detailing a process flow enabled by system 100 of FIG. 1 for managing informational sessions in an auditorium, in accordance with embodiments of the present invention.

FIG. 5 illustrates a computer system used by or comprised by the system of FIG. 1 for enabling a process for automatically selecting audience members associated with informational sessions in an auditorium, in accordance with embodiments of the present invention.

### DETAILED DESCRIPTION

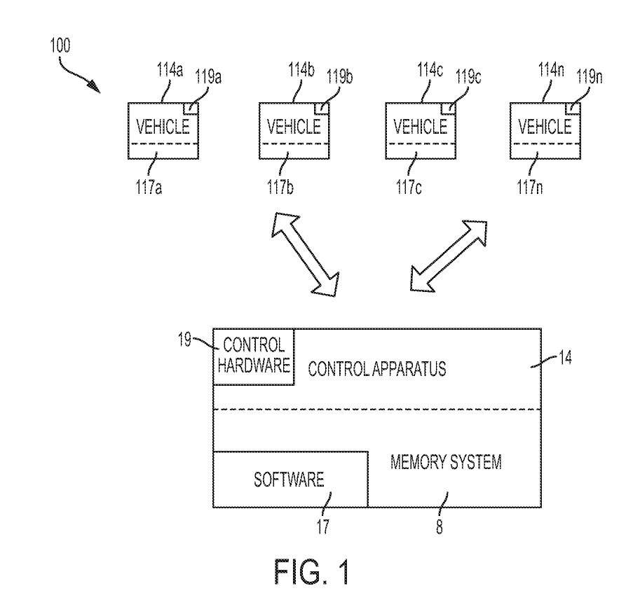

FIG. 1 illustrates a system 100 for enabling vehicles 114a . . . 114n for automatically selecting audience members associated with informational sessions in an auditorium, in accordance with embodiments of the present invention. System 100 enables a process for automated vehicle based selection process by:

Dividing an auditorium into multiple virtual quadrants and automatically detecting a location of an audience member attempting to ask a question (e.g., raises a hand, stands up, etc.). In response, a vehicle (flight) trajectory (for navigation towards the audience member) is determined based on: video feed analysis associated with retrieved facial and voice data and/or a determined eye and hand position and direction. Alternatively, an audience member attempting to ask a question may be selected via a an online polling process or via an audience facial scanning process associated with audience members associated with a specified virtual quadrant with respect to audience profiles from a social based network. An audience member waiting time (to ask a question) may be reduced by performing a predictive analysis via multiple vehicles based on image analysis, video feed analysis, and/or audience profile and historical analysis. System improves vehicle control system technology by implementing specialized internal circuitry for executing an automated process for analyzing audience member motions and selecting an audience member based on the analysis.

System 100 of FIG. 1 includes a control apparatus 14 in communication with vehicles 114a . . . 114n (comprising audio/video (retrieval) devices 117a . . . 117n such as, inter alia, a microphone, a video camera, etc.) via a wireless network 118. Vehicles 114a . . . 114n (i.e., control hardware 119a . . . 119n internal to vehicles 114a . . . 114n) and control apparatus 14 each may comprise an embedded computer. An embedded computer is defined herein as a remotely portable dedicated computer comprising a combination of computer hardware and software (fixed in capability or programmable) specifically designed for executing a specialized function. Programmable embedded computers may comprise specialized programming interfaces. Additionally, vehicles 114a . . . 114n (i.e., control hardware 119a . . . 119n internal to vehicles 114a . . . 114n vehicles) and control apparatus 14 may each comprise a specialized hardware device comprising specialized (non-generic) hardware and circuitry (i.e., specialized discrete non-generic analog, digital, and logic based circuitry) for executing a process described with respect to FIGS. 1-5. The specialized discrete non-generic analog, digital, and logic based circuitry may include proprietary specially designed components (e.g., a specialized integrated circuit designed for only implementing an automated process for automatically selecting audience members associated with informational sessions in an auditorium. Control apparatus 14 includes a memory system 8, software 17, and control hardware 19 (all sensors and associated control hardware for enabling software 17 to execute a process for managing informational sessions in an auditorium). Control hardware 119a . . . 119n may include sensors. Sensors may include, inter alia, GPS sensors, video recording devices, optical sensors, weight sensors, etc. The memory system 8 may include a single memory system. Alternatively, the memory system may include a plurality of memory systems. Each of vehicles 114a . . . 114n may comprise any vehicle that does not require a human operator to be located within the vehicles 114a . . . 114n such as, inter alia, a remote controlled vehicle (e.g., an aircraft flown by a pilot at a ground control station), an autonomously controlled vehicle (e.g., an aircraft controlled based on pre-programmed flight plans and may include an intelligence algorithm that would enable vehicles 114a . . . 114n to know it's location and self-determine a route to an audience member), a pre-programmed vehicle, etc. Alternatively, vehicles 114a . . . 114n may comprise any type of vehicle that includes a human operator located within the vehicle (e.g., an aircraft, an automobile, a boat or ship, a train, etc.). Vehicles 114a . . . 114n may include, inter alia, an aerial vehicle, a land based vehicle, a marine (water) based vehicle, etc.

System 100 of FIG. 1 enables a process for a vehicular based selection process associated with informational sessions in an auditorium by dividing and managing virtual quadrants of the auditorium and directing a vehicle towards users attempting to ask a question. A vehicle (e.g., one of vehicles 114a . . . 114n) may be directed towards users based on a video feed analysis process configured to retrieve associated facial and voice data: as follows:

An auditorium space (e.g., an interior portion of a structure) is divided into a plurality of virtual quadrants and each quadrant is managed by a vehicle(s). Each vehicle comprises an embedded audio retrieval device (e.g., a microphone) such that any audible sound occurring adjacent to the vehicle may be identified via the embedded audio retrieval device. Each vehicle continuously monitors a video feed projecting an associated quadrant and detects a location (e.g., via contextual image analysis) of users raising their hands or standing-up with respect to a request for asking a question (e.g., with respect to a speaker addressing the users). In response, the vehicle initiates motion towards the user based on the video feed. When the vehicle approaches the user, the audio retrieval device is released and enabled such that the user is able to ask a question. The vehicle may maintain a sufficient gap between the audio retrieval device and noisy mechanical portions of the vehicle (e.g., a motor, a drive mechanism, etc.) to decrease noise with respect to a voice input to the audio retrieval device. Additionally, the vehicle may enable onboard audio filters for removing background noises and amplifying vocal noise. Additionally, the vehicle may capture (e.g., via an onboard video retrieval device) a visual image of the user and present the visual image on a public display in combination with the users recorded voice thereby improves an overall user experience with respect to crowd response management.

A vehicle executing a predictive analysis and co-operation process with respect to additional vehicles may be used to reduce the user's waiting time with respect to asking a question as follows: The vehicle executes a predictive analysis process comprising a visual image analysis, a user profile analysis, and a historical analysis. In response, a user is predictively selected with respect to requesting a question. Multiple vehicles receive the user selection to optimize a travel time from an initial location to the user location such that idle travel time is reduced. For example, multiple vehicles receive the user selection and a vehicle located a shorted distance from the user is directed to the user.

A vehicle may execute a process for scanning faces of users in an associated quadrant and preloading associated user profiles from a website with respect to resolving timely ambiguities as follows: Within a quadrant, many users may simultaneously raise their hands with respect to asking a question and in response a vehicle must select one of the users. The selection process may include scanning (i.e., retrieving video) the faces of all of the users (within the quadrant) during a speaker initiated information session. In response, profiles of the users are retrieved (from online-web-sites) and associated with seat positions of the users. The associated seat positions in combination with results of the scanning process are used to select a user for asking a question. Additionally, social network information (of the users) may be used to select heterogeneous users associated with questions of various backgrounds. Alternatively, a vehicle may enable an online polling process for selecting a next user to ask a question. For example, users transmit questions to the vehicle via a mobile device during a previous being answered by a speaker and in response the vehicle may generate and transmit an online polling with respect to various possible next questions to a user's mobile device for selection of a next user question.

Vehicles may determine a travel path (e.g., a flight trajectory) based on a position and direction a speaker's eye and hand as follows: A vehicle monitors and analyzes a visual image of a speaker and based on a position and direction a speaker's eye and hand, the vehicle determines a position of a user requesting to ask a question. In response, the vehicle travels to the determined position of the user.

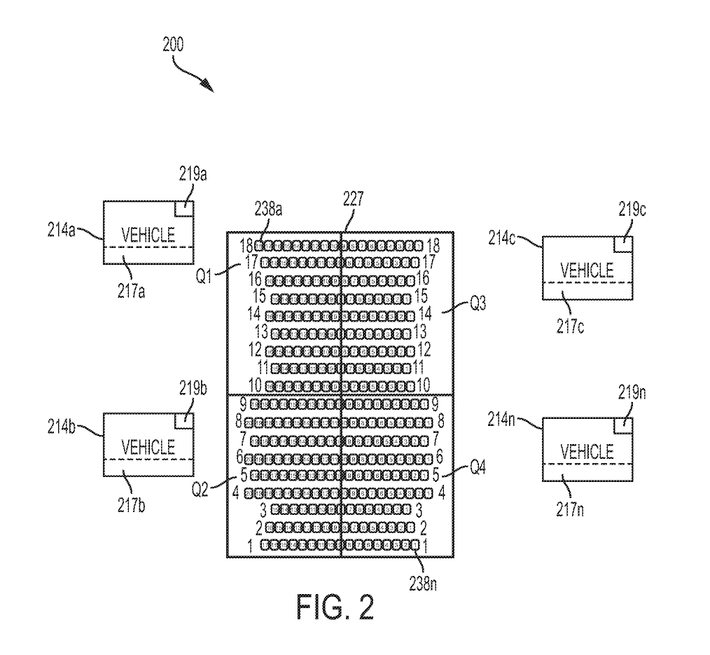

FIG. 2 illustrates a system 200 comprising vehicles 214a . . . 214n enabled to automatically select audience members 238a . . . 238n participating in informational sessions in an auditorium 227, in accordance with embodiments of the present invention. Vehicles 214a . . . 214n comprises control hardware 219a . . . 219n (including sensors) and audio/video devices 217a . . . 217n as described with respect to FIG. 1, supra. Auditorium 227 is divided into four virtual quadrants Q1-Q4. Each of quadrants Q1-Q4 comprises rows (e.g., of rows 1-18) and associated seats (e.g., of seats 1-20 in each row) comprising an associated portion of audience members 238a . . . 238n. Vehicle 214a is associated with quadrant Q1. Vehicle 214b is associated with quadrant Q2. Vehicle 214c is associated with quadrant Q3. Vehicle 214n is associated with quadrant Q4. Each of vehicles 214a . . . 214n continuously monitors a video feed of an associated quadrant (of quadrants Q1-Q4) via execution of a contextual image analysis process. In response, vehicles 214a . . . 2146n detect locations (within associated quadrants Q1-Q4) of individuals raising their hands or standing-up with respect to asking a question for a speaker or moderator of the informational session. Upon detection of an individual (asking a question), an associated vehicle flies towards the individual based on video feeds and upon reaching the individual, the vehicle drone releases a microphone so that the individual is able to ask a question. Additionally, the vehicle (i.e., circuitry in the vehicle) may apply online voice filters for removal of any background noise such that the individual's voice is received clearly.

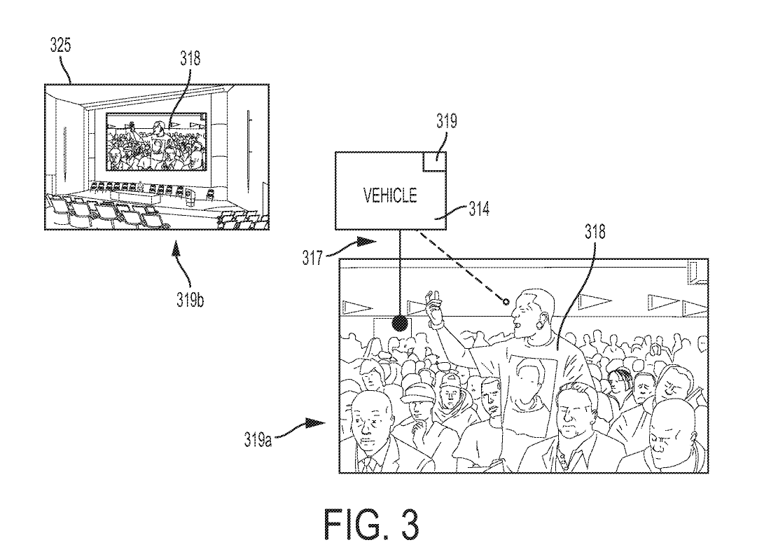

FIG. 3 illustrates an actual view 319a of an individual 318 and a projected view 319b of individual 318, in accordance with embodiments of the present invention. Actual view 319a illustrates a vehicle 314 comprising control hardware 319 (including sensors) and an audio/video device 317 (comprising a microphone and video retrieval device) as described with respect to FIG. 1, supra. Vehicle 314 has automatically selected an audience member (i.e., individual 318) participating (i.e., asking a question) in an informational session in an auditorium 332. As illustrated in FIG. 3, vehicle 314 has captured an image of a face of the individual 318 for projection on a screen 325 of view 319b. Additionally, a captured voice of the individual 318 may be projected (for an audience) in combination with the image of the face of the individual 318 thereby improving an overall user experience for crowd response management. Vehicle 314 is configured to execute a predictive analysis and proactively reach individual 318 based on image and user profile analysis. Additionally, a historical analysis process may be executed to predict question seeking individuals.

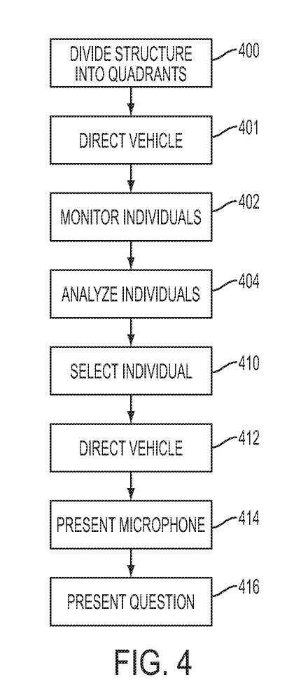

FIG. 4 illustrates an algorithm detailing a process flow enabled by system 100 of FIG. 1 for managing informational sessions in an auditorium, in accordance with embodiments of the present invention. Each of the steps in the algorithm of FIG. 4 may be enabled and executed in any order by a computer processor(s) or any type of specialized hardware executing computer code. In step 400, an interior portion of a structure (comprising a plurality of individuals gathered for an information session) is divided into a plurality of virtual quadrants. In step 401, a specified vehicle is directed to a specified quadrant of the virtual quadrants. The specified quadrant comprises a group of individuals. In step 402, the group of individuals within the specified quadrant is monitored via the vehicle in motion. In step 404, the group of individuals is analyzed based on results of step 402. The monitoring and analysis process of steps 402 and 404 may include the following processes:
1. The monitoring process includes scanning (via a video device of the vehicle) faces of the group of individuals. In response, the analyses process includes: retrieving online profiles for each individual of the group of individuals; comparing each face to an associated profile; and determining locations for each individual based on results of the comparison.
2. The monitoring process includes scanning (via a video device of the vehicle) motions of the group of individuals. In response, the analyses process includes: determining (based on the motions) specified individuals performing specified motions associated with requesting a microphone for asking questions; and determining locations for each of the specified individuals based on the specified motions.
3. The monitoring process includes retrieving (via a receiver device of the vehicle from mobile devices of specified individuals) questions with respect to the information session. In response, the analyses process includes: identifying an individual based on analysis of the questions.
4. The monitoring process includes retrieving (via a video device of the vehicle) images of the group of individuals. In response, the analyses process includes: retrieving social network profiles for each individual; and analyzing the social network profiles with respect to the images.

In step 410, a first individual (of the group of individuals) is selected. The first individual is determined to have a question with respect to the information session. In step 412, the vehicle is directed to a precise location (within the specified quadrant) of the first individual. In step 414, a microphone is presented (via the vehicle) to the first individual such that the first individual recites a question via the microphone. In step 416, the question is presented to a speaker and audience members of the information session.

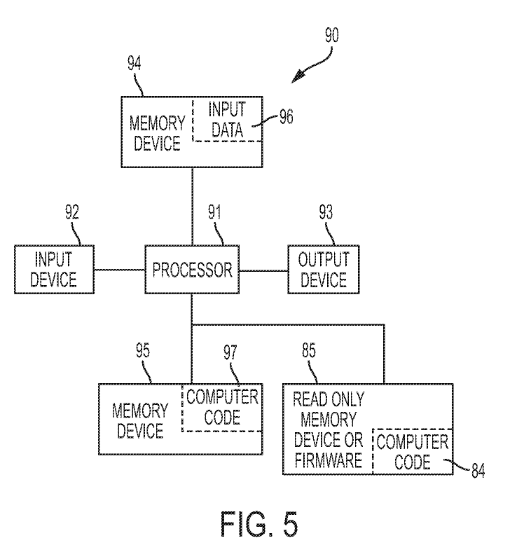

FIG. 5 illustrates a computer system 90 (e.g., control hardware 119a . . . 119n internal to vehicles 114a . . . 114n and control apparatus 14) used by or comprised by the systems of FIGS. 1-3 for enabling a process for automatically selecting audience members associated with informational sessions in an auditorium, in accordance with embodiments of the present invention.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system 90 illustrated in FIG. 5 includes a processor 91, an input device 92 coupled to the processor 91, an output device 93 coupled to the processor 91, and memory devices 94 and 95 each coupled to the processor 91. The input device 92 may be, inter alia, a keyboard, a mouse, a camera, a touchscreen, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 4) for enabling a process for automatically selecting audience members associated with informational sessions in an auditorium. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms (e.g., the algorithm of FIG. 4) and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 84 (e.g., including an algorithm) may be stored on a static, nonremovable, read-only storage medium such as a Read-Only Memory (ROM) device 85, or may be accessed by processor 91 directly from such a static, nonremovable, read-only medium 85. Similarly, in some embodiments, stored computer program code 97 may be stored as computer-readable firmware 85, or may be accessed by processor 91 directly from such firmware 85, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to enable a process for automatically selecting audience members associated with informational sessions in an auditorium. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for automatically selecting audience members associated with informational sessions in an auditorium. In another embodiment, the invention provides a business method that performs the process steps of the invention on a subscription, advertising, and/or fee basis. That is, a service supplier, such as a Solution Integrator, could offer to enable a process for enabling a process for automatically selecting audience members associated with informational sessions in an auditorium. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. An automated selection method comprising:
directing, by a processor of a controller, a vehicle to an interior portion of a structure comprising a plurality of individuals gathered for an information session;
directing, by said processor, said vehicle to a specified quadrant of said interior portion of said structure, said specified quadrant comprising a group of individuals of said plurality of individuals;
monitoring, by said processor via said vehicle in motion, said group of individuals within said specified quadrant of said structure;
analyzing, by said processor, said group of individuals based on results of said monitoring;
selecting, by said processor based on results of said analyzing, a first individual of said group of individuals, said first individual determined to have a question with respect to said information session;
directing, by said processor, said vehicle to a precise location of said first individual;
presenting, by said processor to said first individual via said vehicle, a microphone, wherein said first individual recites said question via said microphone; and
presenting, by said processor to a speaker of said information session and said plurality of individuals via said microphone, said question.

2. The method of claim 1, wherein said monitoring comprises scanning via a video device of said vehicle, faces of said group of individuals, and wherein said analyzing comprises:
retrieving online profiles for each individual of said group of individuals;
comparing each face of said faces to an associated profile of said profiles; and
determining based on results of said comparing, locations for each said individual.

3. The method of claim 1, wherein said monitoring comprises scanning via a video device of said vehicle, motions of said group of individuals, and wherein said analyzing comprises:
determining based on said motions, specified individuals of said group of individuals performing specified motions associated with requesting said microphone for asking questions; and
determining based on said specified motions, locations for each of said specified individuals.

4. The method of claim 1, wherein said monitoring comprises retrieving via a receiver device of said vehicle from mobile devices of specified individuals of said group of individuals, questions with respect to said information session, and wherein said analyzing comprises:
identifying based on analysis of said questions, said first individual.

5. The method of claim 4, wherein said retrieving occurs during previous questions presented by individuals of said group of individuals being answered by said speaker of said information session.

6. The method of claim 1, wherein said monitoring comprises retrieving via a video device of said vehicle, images of said group of individuals, and wherein said analyzing comprises:
retrieving social network profiles for each individual of said group of individuals; and
additionally analyzing said social network profiles with respect to said images.

7. The method of claim 1, further comprising:
additionally monitoring, by said processor via said vehicle in motion, said speaker; and
additionally analyzing, by said processor, said speaker based on results of said additionally monitoring, wherein said selecting is further based on results of said additionally analyzing.

8. The method of claim 1, further comprising:
dividing, by said processor, said interior portion of said structure into a plurality of quadrants, wherein said plurality of quadrants comprise said specified quadrant; and
directing, by said processor, additional vehicles to each of said plurality of quadrants for monitoring said plurality of individuals for additional questions.

9. The method of claim 1, further comprising:
enabling, by said processor via said vehicle, noise filters associated with filtering background noise from said microphone.

10. The method of claim 1, further comprising:
providing at least one support service for at least one of creating, integrating, hosting, maintaining, and deploying computer-readable code in the control hardware, said code being executed by the computer processor to implement: said directing said vehicle to said interior portion, said directing said vehicle to said specified quadrant, said monitoring, said analyzing, said selecting, said directing said vehicle to said precise location, said presenting said microphone, and said presenting said question.

11. A computer program product, comprising a computer readable hardware storage device storing a computer readable program code, said computer readable program code comprising an algorithm that when executed by a processor of a controller implements an automated selection method, said method comprising:
directing, by said processor, a vehicle to an interior portion of a structure comprising a plurality of individuals gathered for an information session;
directing, by said processor, said vehicle to a specified quadrant of said interior portion of said structure, said specified quadrant comprising a group of individuals of said plurality of individuals;
monitoring, by said processor via said vehicle in motion, said group of individuals within said specified quadrant of said structure;
analyzing, by said processor, said group of individuals based on results of said monitoring;
selecting, by said processor based on results of said analyzing, a first individual of said group of individuals, said first individual determined to have a question with respect to said information session;
directing, by said processor, said vehicle to a precise location of said first individual;
presenting, by said processor to said first individual via said vehicle, a microphone, wherein said first individual recites said question via said microphone; and
presenting, by said processor to a speaker of said information session and said plurality of individuals via said microphone, said question.

12. The computer program product of claim 11, wherein said monitoring comprises scanning via a video device of said vehicle, faces of said group of individuals, and wherein said analyzing comprises:
retrieving online profiles for each individual of said group of individuals;
comparing each face of said faces to an associated profile of said profiles; and
determining based on results of said comparing, locations for each said individual.

13. The computer program product of claim 11, wherein said monitoring comprises scanning via a video device of said vehicle, motions of said group of individuals, and wherein said analyzing comprises:
determining based on said motions, specified individuals of said group of individuals performing specified motions associated with requesting said microphone for asking questions; and
determining based on said specified motions, locations for each of said specified individuals.

14. The computer program product of claim 11, wherein said monitoring comprises retrieving via a receiver device of said vehicle from mobile devices of specified individuals of said group of individuals, questions with respect to said information session, and wherein said analyzing comprises:
identifying based on analysis of said questions, said first individual.

15. The computer program product of claim 14, wherein said retrieving occurs during previous questions presented by individuals of said group of individuals being answered by said speaker of said information session.

16. The computer program product of claim 11, wherein said monitoring comprises retrieving via a video device of said vehicle, images of said group of individuals, and wherein said analyzing comprises:
retrieving social network profiles for each individual of said group of individuals; and
additionally analyzing said social network profiles with respect to said images.

17. The computer program product of claim 11, wherein said method further comprises:
additionally monitoring, by said processor via said vehicle in motion, said speaker; and
additionally analyzing, by said processor, said speaker based on results of said additionally monitoring, wherein said selecting is further based on results of said additionally analyzing.

18. The computer program product of claim 11, wherein said method further comprises:
dividing, by said processor, said interior portion of said structure into a plurality of quadrants, wherein said plurality of quadrants comprise said specified quadrant; and
directing, by said processor, additional vehicles to each of said plurality of quadrants for monitoring said plurality of individuals for additional questions.

19. The computer program product of claim 11, wherein said method further comprises:
enabling, by said processor via said vehicle, noise filters associated with filtering background noise from said microphone.

20. A controller comprising a processor coupled to a computer-readable memory unit, said memory unit comprising instructions that when executed by the processor executes an automated selection method comprising:
directing, by said processor, a vehicle to an interior portion of a structure comprising a plurality of individuals gathered for an information session;
directing, by said processor, said vehicle to a specified quadrant of said interior portion of said structure, said specified quadrant comprising a group of individuals of said plurality of individuals;
monitoring, by said processor via said vehicle in motion, said group of individuals within said specified quadrant of said structure;
analyzing, by said processor, said group of individuals based on results of said monitoring;
selecting, by said processor based on results of said analyzing, a first individual of said group of individuals, said first individual determined to have a question with respect to said information session;
directing, by said processor, said vehicle to a precise location of said first individual;
presenting, by said processor to said first individual via said vehicle, a microphone, wherein said first individual recites said question via said microphone; and
presenting, by said processor to a speaker of said information session and said plurality of individuals via said microphone, said question.
